(19) United States
(12) Patent Application Publication
(10) Pub. No.: US 2025/0324503 A1
(43) Pub. Date: Oct. 16, 2025

(54) POWER SYSTEM FOR LINAC-BASED X-RAY SOURCE

(71) Applicant: RadiaBeam Technologies, LLC, Santa Monica, CA (US)

(72) Inventor: Evgeny Ivanov, Los Angeles, CA (US)

(21) Appl. No.: 19/000,362

(22) Filed: Dec. 23, 2024

Related U.S. Application Data
(60) Provisional application No. 63/624,708, filed on Jan. 24, 2024.

(51) Int. Cl. H05G 1/32; H05G 1/12; H05G 1/24

(52) U.S. Cl. CPC H05G 1/32; H05G 1/12; H05G 1/24

(57) ABSTRACT

A modulator is configured to provide pulse power output signals to a linac-based x-ray source. The modulator includes control circuitry on at least one first printed circuit board and driver circuitry on at least one second printed circuit board in reversible mechanical and electrical communication with the at least one first printed circuit board. The driver circuitry includes a driver loop wire extending from the at least one second printed circuit board. The modulator further includes a plurality of Marx cells on a plurality of third printed circuit boards in reversible mechanical and electrical communication with the at least one first printed circuit board. Each Marx cell includes a transformer configured to trigger the Marx cell, and the driver loop wire includes a common primary winding of the transformers of the plurality of Marx cells.

### BACKGROUND

### Field

This application relates generally to power systems for linear accelerator-based x-ray sources.

### Description of the Related Art

Portable x-ray sources are widely used by security, nuclear safeguards, and defense agencies. Their current and potential applications include cargo inspection, inspection of munitions for defects, nuclear explosives investigation, explosives disposal, aircraft inspection, verification and characterization of nuclear fuel and materials, as well as nondestructive testing. See, e.g., S. V. Kutsaev, “Advanced technologies for applied particle accelerators and examples of their use (review),” Tech. Phys., vol. 66, no. 2, pp. 161-195, doi: 10.1134/S1063784221020158 (2021); B. L. Doyle et al., “The future of industrial accelerators and applications,” Rev. Accel. Sci. Technol., vol. 10, no. 1, pp. 93-116, doi: 10.1142/s1793626819300068 (2019); A. J. Antolak, “Overview of accelerator applications for security and defense,” Rev. Accel. Sci. Technol., vol. 08, pp. 27-36, doi: 10.1142/S1793626815300029 (2016). At the same time, conventional x-ray sources have significant drawbacks greatly affecting their practical use.

For example, radioisotope-based gamma sources have many associated safety and security issues. Some isotopes, such as Co-60 or Ir-192, must eventually be replenished, adding operating expense, quality assurance challenges, and endangering the safety of users. Additionally, the radiation cannot be turned off-continually emitting equally in every direction. Radiological incidents have sparked discussions and reaffirmed the determination to replace these isotopes in the near future.

A safer alternative is electronic-based generation of radiation. Betatrons currently used in field non-destructive testing (NDT) missions have very low-dose emissions due to their low duty cycle, nonideal size, weight, and power (SWaP) characteristics and are impractical for many field operations. For example, the Instauro Ltd. SEA-2.5M betatron, which is currently used in field NDT missions, weighs as much as 120 lbs., making it difficult to be carried by a single person.

In contrast, low-energy radiography systems utilizing x-ray tubes with energies in the range of 150-370 keV have significant drawbacks identified by users that cause operational issues for field radiography. These x-ray sources have limited energy variability, so two or more x-ray generators are carried and used if different thicknesses are to be inspected. Variable dose rates are also limited but are utilized for safety and performance. In addition, the repetition rate of x-ray tubes is limited to 25 Hz, and they suffer from unstable timing and voltage drop issues, due to the use of discharger-based voltage generators, which prevents precision and long-term synchronization with detectors.

### SUMMARY

In certain implementations, a modulator is configured to provide pulse power output signals to a linac-based x-ray source. The modulator comprises control circuitry on at least one first printed circuit board and driver circuitry on at least one second printed circuit board in reversible mechanical and electrical communication with the at least one first printed circuit board, such that the driver circuitry is in operative communication with the control circuitry. The driver circuitry comprises a driver loop wire extending from the at least one second printed circuit board. The modulator further comprises a plurality of Marx cells on a plurality of third printed circuit boards in reversible mechanical and electrical communication with the at least one first printed circuit board, such that the plurality of Marx cells is in operative communication with the control circuitry and the driver circuitry. The plurality of Marx cells is configured to generate pulse power output signals. Each Marx cell of the plurality of Marx cells comprises a transformer configured to trigger the Marx cell, and the driver loop wire comprises a common primary winding of the transformers of the plurality of Marx cells.

In certain implementations, an x-ray generating system comprises an x-ray source and a radio-frequency (RF) voltage power supply configured to provide electrical power to the x-ray source. The x-ray source comprises an electron source configured to provide electrons, a linear accelerator configured to receive the electrons from the electron source and to apply radio-frequency (RF) electromagnetic fields to accelerate the electrons, a magnetron configured to generate the RF electromagnetic fields, and a target configured to respond to being impinged by the accelerated electrons by generating x-rays. The RF voltage power supply comprises a battery, a DC power source, and a modulator configured to receive electrical power from the battery and the DC power source and to provide pulse power signals to the electron source and the magnetron of the x-ray source. The modulator comprises a driving signal conduit and a plurality of cells configured to generate the pulse power signals. Each cell of the plurality of cells comprises a capacitor bank and a transformer configured to trigger the cell. The driving signal conduit comprises a common primary winding of the transformers of the plurality of cells.

### BRIEF DESCRIPTION OF THE DRAWINGS

FIG. 1 schematically illustrates an example system in accordance with certain implementations described herein.

FIG. 2 schematically illustrates an example block diagram of the example system in accordance with certain implementations described herein.

FIG. 3A is a photograph of an example modulator in accordance with certain implementations described herein.

FIG. 3B schematically illustrates the example modulator of FIG. 3A operatively coupled to the battery and the DC power source in accordance with certain implementations described herein, and FIG. 3C schematically illustrates example control circuitry in accordance with certain implementations described herein.

FIG. 4 schematically illustrates example driver circuitry in accordance with certain implementations described herein.

FIG. 5A is a photograph of an example third PCB having example first and second Marx cells in accordance with certain implementations described herein.

FIG. 5B schematically illustrates the example PCB and the example first and second Marx cells of FIG. 5A in accordance with certain implementations described herein.

FIG. 6 schematically illustrates the plurality of third PCBs connected in series with one another in accordance with certain implementations described herein.

FIG. 7 is a plot of example measured voltage and current waveforms at the output of the modulator connected to a resistive load of 1000 Ohms in accordance with certain implementations described herein.

FIG. 8 is a plot of example measured RF signal envelope and example frequency spectrum at the output of the modulator connected to the magnetron in accordance with certain implementations described herein.

FIG. 9 is a plot of example measured voltage and current waveforms at the output of the modulator connected to the magnetron in accordance with certain implementations described herein.

FIG. 10 is a plot of an example RF power generated by the magnetron as a function of the pulse voltage of the modulator in accordance with certain implementations described herein.

### DETAILED DESCRIPTION

RF linear accelerators (referred to herein as “linacs”) can provide a flexible, reliable, and robust radiation source and be used for both low (e.g., less than 1 MeV) and high (e.g., greater than 1 MeV). Linacs are configured to receive charged particles (e.g., electrons) from a particle source and to apply radio-frequency (RF) electromagnetic fields to accelerate the charged particles. Unlike radioisotope systems that have decreasing output due to radioactive decay, linacs can produce constant output throughout their lifetime. Unlike betatrons, linacs can provide high radiation doses. Unlike x-ray tubes, linacs can have a wider range of parameter variability. A linac can have size, weight, cost, and imaging performance that are better than that of a radioisotope system. For example, certain implementations described herein are compatible with a linac-based x-ray source having a weight of 35 to 50 lbs., a cost of less than $50,000, and a dose rate exceeding 1 cGy/min.

Certain implementations described herein provide a human-portable (e.g., capable of being carried by a single person; total weight of 50 pounds or less) x-ray source based on a Ku-band electron linac that differs from previously-developed linac-based systems. See, e.g., S. V. Kutsaev et al., “Radioisotope replacement with compact electron linear accelerators,” Nucl. Instrum. Methods Phys. Res. B, Beam Interact. Mater. At., vol. 540, pp. 12-18, doi: 10.1016/J.NIMB2023.04.004 (2023); S. V. Kutsaev et al., “Ir-192 radioisotope replacement with a hand-portable 1 MeV Ku-band electron linear accelerator,” Appl. Radiat. Isot., vol. 179, article no. 110029, doi: 10.1016/j.apradiso.2021.110029 (2022); S. V. Kutsaev et al., “Sub-MeV ultra-compact linac for radioactive isotope sources replacement, non-destructive testing, security and medical applications,” Nucl. Instrum. Methods Phys. Res. B, Beam Interact. with Mater. At., vol. 459, pp. 179-187, doi: 10.1016/j.nimb.2019.08.029 (2019); A. Y. Smirnov et al., “Cost-efficiency enhancement of X- and Ku-band split waveguides for industrial accelerators,” Nucl. Instrum. Methods Phys. Res. A, Accel. Spectrom. Detect. Assoc. Equip., p. 168638, doi: 10.1016/j.nima.2023.168638 (2023); S. V. Kutsaev et al., “Man-portable linac-based X-ray sources for NDT and nuclear security applications,” Proc. Int. Conf. Environ. Remediation Radioact. Waste Manag. (ICEM), Stuttgart, Germany (2023).

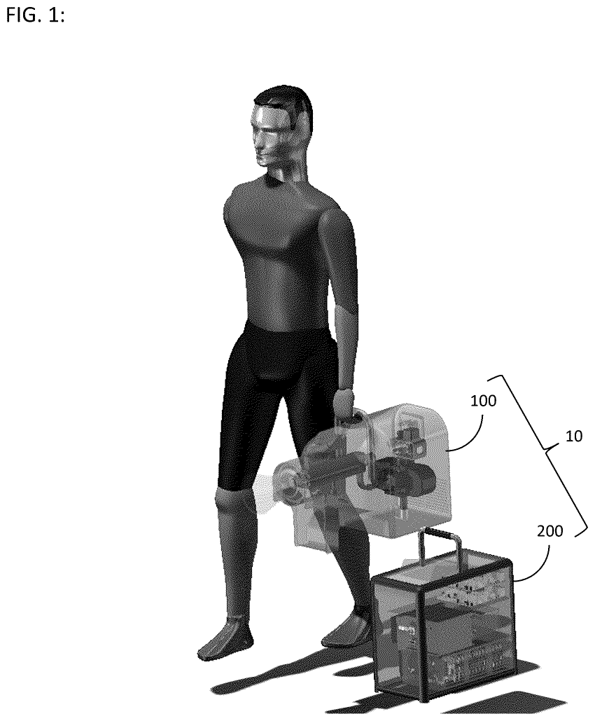

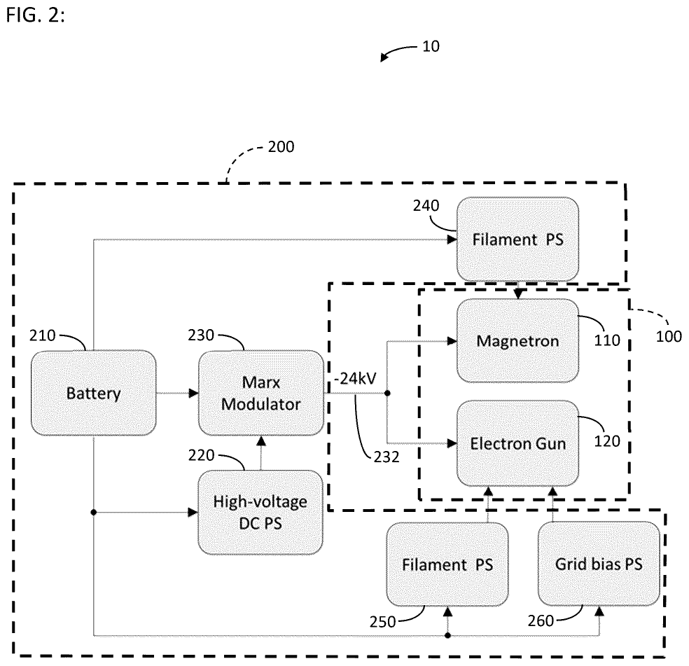

FIG. 1 schematically illustrates an example system 10 in accordance with certain implementations described herein and FIG. 2 schematically illustrates an example block diagram of the example system 10 in accordance with certain implementations described herein. The example system 10 comprises a linac-based x-ray source 100 (e.g., comprising an electron gun and a magnetron) and a radio-frequency (RF) high-voltage power supply 200 configured to provide electrical power to components of the x-ray source 100 (e.g., high voltage pulses in a range of 21 kV to 24 kV). In certain implementations, the system 10 is self-powered (e.g., configured to operate without an external power source), and its weight, including the x-ray source 100 and the power supply 200, does not exceed 50 lbs. Table 1 lists some example parameter sets of the example system 10 in accordance with certain implementations described herein.

TABLE 1

| | Set 1 | Set 2 | Set 3 | Set 4 |
|---|---|---|---|---|
| Energy (MeV) | 2.0 | 1.0 | 0.15-0.37 | 0.18 |
| Frequency (GHz) | | 15.14 | 15.14 | 16.4 |
| Peak RF power (kW) | | 250 | 250 | |
| Maximum current (μA) | 10 | 100 | 200 | 10 |
| Maximum power (W) | 20 | 100 | 75 | 2 |
| X-ray dose [est. 1 meter from | 5 | 10 | 5 | less |
| linac head] (R/minute) | | | | than 1 |
| Size [L × W × H] (inches) | | 12 × | 12 × | 8 × |
| | | 12 × 6 | 12 × 6 | 7 × 4 |
| Weight (lbs) | | ~50 | ~50 | 11 |

In certain implementations, the x-ray source 100 comprises a magnetron 110 and an electron source 120 (e.g., electron gun). For example, the magnetron 110 can comprise an air-cooled, pulsed Ku-band (e.g., 15 and 16 GHz) magnetron configured to provide up to 250 kW of peak RF power at 0.1% duty cycle, 450-ns pulse length, and up to 2250 pulses per second (e.g., VMU1724T magnetron available from CPI Inc. of Beverly MA). The magnetron 110 and the electron source 120 can utilize similar filament heating schemes as one another to provide a low-cost, compact, and efficient solution. The electrons accelerated by the RF electromagnetic fields generated by the magnetron 110 can be directed to impinge a target which is configured to generate x-rays in response.

In certain implementations, the size and weight of the power supply 200 are reduced as compared to conventional power supplies by using high-frequency accelerating structures and power sources, which are smaller due to the shorter wavelength and are also more energy efficient (see, e.g., S. V. Kutsaev, “Novel technologies for compact electron linear accelerators (review),” Instrum. Exp. Techn., vol. 64, no. 5, pp. 641-656, doi: 10.1134/S0020441221050079 (2021). In certain implementations, the power supply 200 is configured to drive the magnetron 110 (e.g., a VMU1724T magnetron) by providing a 24-kV output voltage, 24-A anode current, and pulse duration matching the magnetron 110.

In certain implementations, the power supply 200 comprises a battery 210, an adjustable DC power source 220 (e.g., having an output voltage less than 1 kV), and a modulator 230. The battery 210 is configured to provide electrical power to the DC power source 220 and to the modulator 230, and the DC power source 220 is configured to provide electrical power to the modulator 230. The modulator 230 is configured to provide high-voltage pulse power output signals 232 to the x-ray source 100 (e.g., to both the magnetron 110 and the electron source 120).

In certain implementations, the battery 210 comprises one or more lithium-ion batteries connected in series and/or parallel circuits and has a low output voltage (e.g., in a range greater than or equal to 3 V), a high power density (e.g., in a range greater than 150 Wh/kg), a low self-discharge rate (e.g., in a range of 5%/month to 10%/month), a high energy density (e.g., in a range greater than 150 Wh/kg), a large number of charge cycles (e.g., in a range greater than 300), and substantially no memory effect. Examples of lithium-ion batteries compatible with certain implementations described herein include, but are not limited to PH3059HD29 Li-ion battery available from Inspired Energy, LLC of Newberry FL, which has protection circuitry and can provide an output voltage of 28.8 V with up to 90% efficiency, a maximum output current of 12 A, and power up to 345 W on average. For example, the battery 210 can comprise three such lithium-ion batteries in parallel with cross-current protection circuitry to satisfy a 900-W system draw and having a power capacity of 250 W·h and providing 15 minutes of continuous full-power operation. Other example batteries include but are not limited to Li—Po or LiFePO₄ batteries, having an assembly of elements based on Li-ion chemistry (e.g., high energy density, high output current, suitable voltage, low self-discharge).

In certain implementations, the DC power source 220 is configured to provide an adjustable output voltage (e.g., 850 V with up to 90% efficiency) for charging capacitors of the modulator 230 (e.g., of a plurality of Marx cells 330 as described herein).

The power supply 200 of certain implementations (see, e.g., FIG. 2) further comprises a first filament power source 240, a second filament power source 250, and a grid bias power source 260. The first filament power source 240 is in operative communication with the magnetron 110, and the second filament power source 250 and the grid bias power source 260 are each in operative communication with the electron source 120. The battery 210 is configured to provide electrical power to the first filament power source 240, the second filament power source 250, and the grid bias power source 260. The grid bias power source 260 can comprise a switch and a DC/DC converter with an adjustable output voltage from 0 V to 100 V, the grid bias power source 260 configured to provide pulses to the bias grid of the electron source 120 simultaneously with high-voltage cathode pulses provided to the cathode of the electron source 120 by the second filament power source 250. While FIG. 2 schematically illustrates each of the first filament power source 240, the second filament power source 250, and the grid bias power source 260 as components of the power supply 200, in certain other implementations, one or more of the first filament power source 240, the second filament power source 250, and the grid bias power source 260 are components of the x-ray source 100. The filament power source 250 can have a predetermined output voltage and can be configured to limit the output current (e.g., an adjustable DC source with voltage and current limitation). LED power supplies and other power supplies with CC CV operation modes can also be used.

In certain implementations in which the magnetron 110 and the electron source 120 are both driven by the modulator 230 (see, e.g., FIG. 2), cathode pulses for the magnetron 110 and the electron source 120 are kept at a high potential relative to ground, and the first filament power source 240, the second filament power source 250, and the grid bias power source 260 are isolated from ground during the pulse power output signals 232. In certain implementations, the voltage values for the magnetron 110 and the electron source 120 can be substantially equal to one another, and the power can be supplied by a single modulator. While a high-voltage choke can be used for this isolation during the pulse power output signals 232, to withstand the maximum pulse length and amplitude without saturation, the choke would utilize a large number of turns and a large magnetic core, thereby causing significant resistive losses while increasing the system weight. In certain implementations, the power supply 200 comprises a DC/DC converter and a pulse transformer with isolated primary to secondary windings configured to convert the DC voltage from the battery 210 and provide the isolation (e.g., galvanic isolation) during the pulse power output signals 232. The DC/DC converter can operate without feedback and can have insignificant output voltage variation over the full load range. For example, the DC/DC converter can directly receive power for the filament and can be based on an LM61495RPHEVM evaluation module available from Texas Instruments of Dallas TX (e.g., modified to provide 11 V output voltage).

Conventional modulator topologies (see, e.g., E. G. Cook, “Review of solid state modulators,” Proc. 20th Int. Linear Accel. Conf., Monterey, CA, USA, pp. 663-667 (2000); M. P. J. Gaudreau et al., “Solid state modulator applications in linear accelerators,” Proc. Part. Accel. Conf., pp. 1491-1493, https://accelconf.web.cern.ch/p99/PAPERS/TUP8.PDF (1999)) are unsuitable for certain implementations described herein. For example, conventional modulator topologies can utilize a voltage source (e.g., transformer; voltage multiplier), a storage capacitor charged by the voltage source, and a high-voltage switch configured to dump the stored charge as a current pulse with a calculated drop in peak amplitude, with all the components rated for the full voltage and average power. The voltage source utilizes high-voltage isolation and the high-voltage switch utilizes complex control circuitry with galvanic isolation. The transformer of such a modulator can include a magnetic core, a bulky primary winding, a secondary winding with a large number of turns, and thick insulation or an oil tank for high-voltage safety, making the modulator incompatible with human-portable applications due to weight concerns. In addition, the desired electrical current to be provided to the primary winding of such a modulator (e.g., which can be higher than the electrical current provided by a battery) can utilize an intermediate step-up power supply and high-capacity buffer storage which add additional weight. Furthermore, with a high transformer turn count, low magnetic coupling, and high parasitic capacitance, a conventional modulator can have a large leakage inductance, preventing sharp pulse edges and potentially causing oscillations and the modulator can be unable to provide the desired duty factor for a Ku-band magnetron 110.

In certain implementations, the modulator 230 comprises a compact, solid-state modulator with a Marx topology (see, e.g., M. A. Kemp, “Solid state Marx modulators for emerging applications,” Proc. 26th Int. Linear Accel. Conf. (Linac), Tel-Aviv, Israel, pp. 743-747 (2012)). A Marx topology is based on a large number of capacitors that are simultaneously connected in series with one another and charged to a low voltage to develop a high voltage across the series. Therefore, a high voltage is generated only when closing the discharge switches and is evenly distributed along the capacitor chain. A Marx modulator 230 (e.g., a modulator based on a Marx topology) of certain implementations described herein is compact, efficient, and inexpensive with output parameters for driving a 250-kW Ku-band magnetron 110. The Marx modulator 230 can include individual transistor control for each cell, isolation of the charging circuits of the storage capacitors of the Marx cells for the duration of the pulse, low parasitic parameters, and isolation of the control circuits. In certain implementations, the Marx modulator 230 has a weight in a range of 120 lbs. to 140 lbs., which is significantly reduced as compared to other modulators configured for use with a linac-based x-ray source 100.

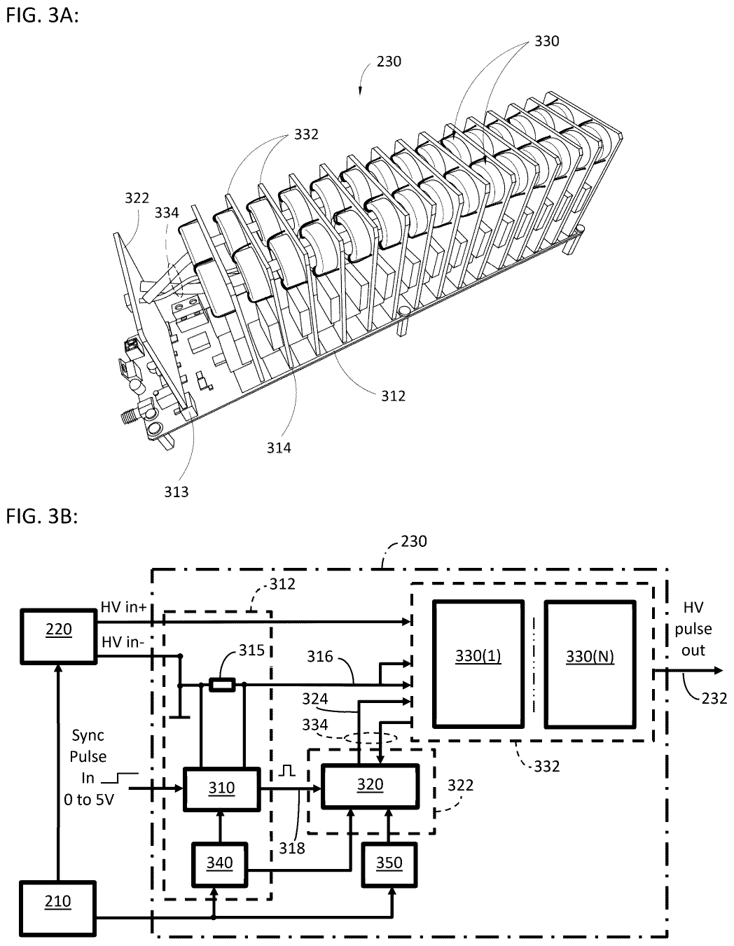

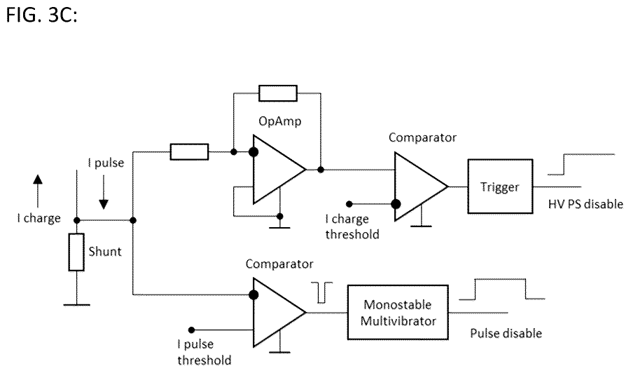

FIG. 3A is a photograph of an example modulator 230 in accordance with certain implementations described herein and FIG. 3B schematically illustrates the example modulator 230 of FIG. 3A operatively coupled to the battery 210 and the DC power source 220 in accordance with certain implementations described herein. The modulator 230 comprises control circuitry 310 on at least one first printed circuit board (PCB) 312 and driver circuitry 320 on at least one second PCB 322 in reversible mechanical and electrical communication with the at least one first PCB 312 (e.g., the at least one second PCB 322 is repeatedly attachable to and detachable from the at least one first PCB 312 without damaging the at least one first PCB 312 or the at least one second PCB 322) such that the driver circuitry 320 is in operative communication with the control circuitry 310. The modulator 230 further comprises a plurality of Marx cells 330 on a plurality of third PCBs 332 in reversible mechanical and electrical communication with the at least one first PCB 312 (e.g., each of the third PCBs 332 is repeatedly attachable to and detachable from the at least one first PCB 312 without damaging the at least one first PCB 312 or the third PCB 332) such that the plurality of Marx cells 330 is in operative communication with the control circuitry 310 and the driver circuitry 320. The plurality of Marx cells 330 is configured to generate pulse power output signals 232 (e.g., to be provided to the linac-based x-ray source 100).

In certain implementations, the at least one first PCB 312 serves as a hub for the driver circuitry 320 and the plurality of Marx cells 330. For example (see, e.g., FIG. 3A), the at least one first PCB 312 can comprise at least one first connector 313 and a plurality of second connectors 314 in electrical communication with the control circuitry 310. The at least one second PCB 322 can be configured to be controllably engaged with (e.g., soldered to; inserted into) the at least one first connector 313 so as to provide electrical communication between the control circuitry 310 and the driver circuitry 320 and to be controllably disengaged (e.g., desoldered; detached) from the at least one first connector 313 (e.g., to remove the at least one second PCB 322 from the modulator 230). Each third PCB 332 can be configured to be controllably engaged with (e.g., soldered to; inserted into) at least one second connector 314 of the plurality of second connectors 314 so as to provide electrical communication between the control circuitry 310 and at least one Marx cell 330 on the third PCB 332 and to be controllably disengaged (e.g., desoldered; detached) from the at least one second connector 314 (e.g., to remove the third PCB 332 from the modulator 230). The at least one first connector 313 and the plurality of second connectors 314 can comprise pin headers, plug-in connections, or can be soldered connections (e.g., with solder pad protrusions and adjacent slots). As further described herein, the third PCBs 332 can be substantially identical and interchangeable with one another and with other replacement third PCBs 332, thereby providing a modular configuration of the modulator 230 (e.g., a third PCB 332 having a faulty Marx cell 330 can be easily removed and replaced by another third PCB 332 with operative Marx cells 330).

In certain implementations (see, e.g., FIG. 3B), the control circuitry 310 is configured to receive input synchronizing pulses (e.g., 0 V to 5 V; TTL levels), to provide power (e.g., via a shunt resistor 315) and timing control pulses 316 to the plurality of Marx cells 330, and to provide output synchronization pulses 318 (e.g., with pulse widths up to 500 ns) to the driver circuitry 320. In addition, the control circuitry 310 comprises protection circuitry configured to protect against pulsed and average current overshoot by turning off the timing control pulses 316 and/or output synchronization pulses 318 or interrupting the power to the plurality of Marx cells 330, respectively. FIG. 3C schematically illustrates example control circuitry 310 in accordance with certain implementations described herein.

In certain implementations (see, e.g., FIG. 3B), the driver circuitry 320 is configured to, in response to the synchronization pulses 318 from the control circuitry 310, provide driving pulses 324 to the driver loop wire 334 of the plurality of Marx cells 330. The driver circuitry 320 can be configured to adjust the pulse duration of the driving pulses 324 (e.g., in a range of 350 ns to 500 ns) provided to the driver loop wire 334.

As shown in FIG. 3B, the modulator 230 can further comprise a low-voltage first DC power source 340 (e.g., about 12 V) and a high-voltage second DC power source 350 (e.g., about 500 V; up to 500 V; in a range of 300 V to 600 V). The first DC power source 340 can be configured to provide electrical power to the control circuitry 310 and the driver circuitry 320. The first DC power source 340 can be integrated into the at least one first PCB 312 (see, e.g., FIG. 3B) or can be separate from the at least one PCB 312. The second DC power source 350 can be configured to provide electrical power to the driver circuitry 320. For example, the second DC power source 350 can comprise a booster converter configured to provide an adjustable DC output voltage. The second DC power source 350 can be integrated into the at least one second PCB 322 (e.g., to further reduce the size and cost of the modulator 230) or can be separate from the at least one second PCB 322 (see, e.g., FIG. 3B). Examples of the first DC power source 340 and/or the second DC power source 350 can include, but are not limited to: a low-dropout (LDO) regulator, a high-voltage boost converter, a flyback converter, a boost converter with a choke.

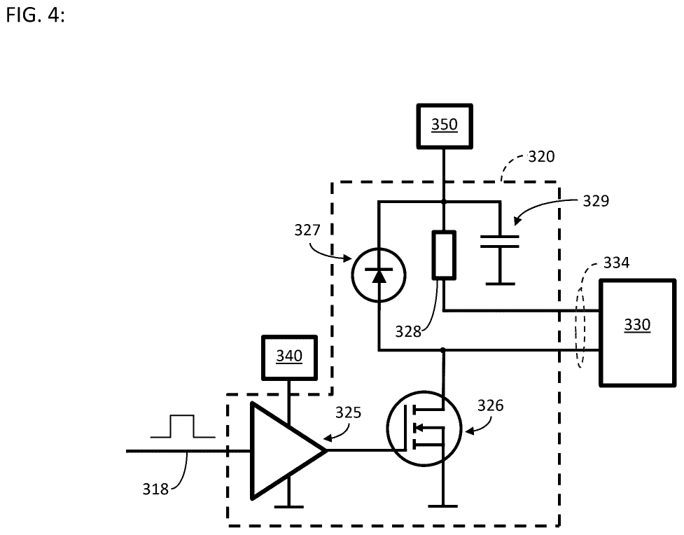

FIG. 4 schematically illustrates example driver circuitry 320 in accordance with certain implementations described herein. As shown in FIG. 4, the driver circuitry 320 can comprise a gate driver 325, a metal-oxide-semiconductor field-effect transistor (MOSFET) 326, a diode 327, a shunt resistor 328, and a capacitor 329. The gate driver 325 can receive the synchronization pulses 318 from the control circuitry 310 and the DC voltage (e.g., +12 V) from the first DC power source 340 and can provide an output signal to the gate of the MOSFET 326. The cathode of the diode 327, a first end of the shunt resistor 328, and a first end of the capacitor 329 can each receive the DC voltage (e.g., less than or equal to +500 V) from the second DC power source 350. The anode of the diode 327 can be connected to the drain of the MOSFET 326 and to a first portion (e.g., end portion) of the driver loop wire 334 of the plurality of Marx cells 330. A second end of the shunt resistor 328 can be connected to a second portion (e.g., end portion) of the driver loop wire 334. A second end of the capacitor 329 can be connected to ground. In this way, the driver circuitry 320 can provide high-voltage driving pulses 324 to the plurality of Marx cells 330 via the driver loop wire 334.

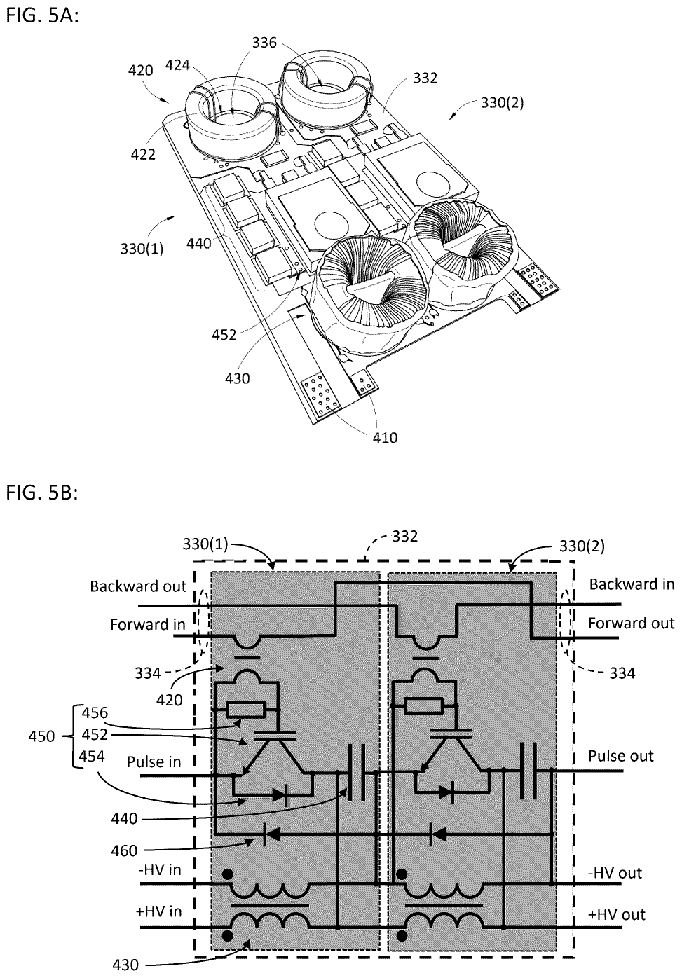

FIG. 5A is a photograph of an example third PCB 332 having example first and second Marx cells 330(1), 330(2) in accordance with certain implementations described herein and FIG. 5B schematically illustrates the example PCB 332 and the example first and second Marx cells 330(1), 330(2) of FIG. 5A in accordance with certain implementations described herein. The third PCB 332 comprises a plurality of connectors 410 configured to receive an input positive high-voltage (“+HV in”) signal, an input negative high-voltage (“−HV in”) signal, and an input pulse (“P in”) signal and to communicate an output positive high-voltage (“+HV out”) signal, an output negative high-voltage (“−HV out”) signal, and an output pulse (“P out”) signal. The plurality of connectors 410 are configured to be controllably engaged with corresponding second connectors 314 of the plurality of second connectors 314 so as to provide electrical communication between the control circuitry 310 and the first and second Marx cells 330(1), 330(2) on the third PCB 332 and to be controllably disengaged from the at least one second connector 314 (e.g., to disconnect the third PCB 332 from the control circuitry 310). For each Marx cell 330 of the third PCB 332, the third PCB 332 further comprises a corresponding orifice 336 configured to have the driver loop wire 334 extend through the orifice 336.

Each Marx cell 330 (e.g., each of the first and second Marx cells 330(1), 330(2)) comprises a transformer 420 configured to trigger or drive the Marx cell 330, an inductor 430 (e.g., charging inductor; choke), a plurality of capacitors 440 (e.g., capacitor bank), transistor circuitry 450, and a diode 460. The transformer 420 can comprise a ferrite toroidal core 422 (e.g., T38 Mn—Fe ferrite material) and a secondary winding (e.g., enameled wire) wound around the core 422 with a plurality of turns (e.g., 35), and a center hole 424 encircled by the core 422. The center hole 424 of the transformer 420 is aligned with (e.g., positioned over) a corresponding orifice 336 of the third PCB 332 such that the driver loop wire 334 can extend through the center hole 424 of the transformers 420 of each of the Marx cells 330. For example, as shown in FIG. 3A, the driver loop wire 334 extends in a first direction (e.g., in a forward direction) through the orifices 336 and the center holes 424 of the toroidal cores 422 of each of the first Marx cells 330(1) of the plurality of third PCBs 332 and extends in a second direction opposite to the first direction (e.g., in a backward direction) through the orifices 336 and the center holes 424 of the toroidal cores 422 of each of the second Marx cells 330(2) of the plurality of third PCBs 332. For example, a toroidal magnetic core can provide a sufficiently low leakage inductance and a sufficiently high voltage gap between the primary and secondary windings of the transformer 420.

As shown in FIG. 4, the ends of the driver loop wire 334 can be in reversible mechanical and electrical communication with the at least one second PCB 322 (e.g., the ends of the driver loop wire 334 are repeatedly attachable to and detachable from the rest of the driver circuitry 320 on the at least one second PCB 322 without damaging the driver loop wire 334 or the at least one second PCB 322). For example, the ends of the driver loop wire 334 can be soldered to the at least one second PCB 322 or inserted into an electrical connector of the at least one second PCB 322. By extending through each of the transformers 420, the driver loop wire 334 can serve as a common primary winding for each of the transformers 420, allowing precise synchronization of the transistor circuitry 450 of all of the Marx cells 330 (e.g., triggering or driving all the Marx cells 330 at once). Such a configuration can provide a compact solution that omits individual power supplies and driver controls for each of the Marx cells 330.

In addition, the reversible mechanical and electrical connection of the driver loop wire 334 with the at least one second PCB 322 facilitates a modular configuration of the modulator 230. For example, the driver loop wire 334 can be removed from the at least one second PCB 322 and withdrawn from the orifices 336 and holes 424 so that at least one third PCB 332 (e.g., a third PCB 332 having a faulty Marx cell 330) can be detached and removed from the at least one first PCB 312. Once the removed third PCB 332 is replaced by another third PCB 332, the driver loop wire 334 can be replaced to extend through all the orifices 336 and the holes 424 and reattached to the at least one second PCB 322.

The inductor 430 (e.g., common mode choke) is configured to receive the “+HV in” and “−HV in” signals and is in parallel electrical communication with the plurality of capacitors 440 (e.g., ceramic capacitors rated for voltages up to 1500 V) to provide a step-up voltage to the plurality of capacitors 440. For differential currents (e.g., currents in different directions), the inductor 430 can have low inductance (e.g., low resistance) and for common mode currents (e.g., currents in the same direction), the inductor 430 can have high inductance (e.g., high resistance). In this way, the inductor 430 can facilitate the charging of the storage capacitors of the Marx cells and their isolation at the moment of switching the transistors (e.g., at the moment of impulse). The inductor 430 can serve as a low-inductance element for a charging differential current and as a high-inductance element during high-voltage pulse generation. The capacitors 440 of the plurality of capacitors 440 can be connected in parallel electrical communication with one another. For example, the capacitors 440 can comprise four 0.1-μF capacitors (see, e.g., FIG. 5A) and the plurality of capacitors 440 can be configured to provide a pulse flatness of about 3%. The inductor 430 can have two windings (e.g., four ends) would on one magnetic core, with a winding direction compatible with certain implementations described herein.

The transistor circuitry 450 is configured to switch (e.g. open or close) in response to the driving pulses 324 on the driver loop wire 334 to controllably synchronously connect capacitors 440 of the cells with capacitors 440 of the next cells (e.g., providing a pulse voltage of up to 800 V). For example, the transistor circuitry 450 can comprise an insulated-gate bipolar transistor (IGBT) 452, a diode 454, and a shunt resistor 456 (see, e.g., FIG. 5B). The IGBT 452 (e.g., IXYH24N170C transistor available from Littlefuse, Inc. of Chicago, IL) can have a high operating voltage (e.g., 1700 V; in a range of 1200 V to 1700 V), a high overcurrent tolerance (e.g., in a range of 100 A to 200 A; greater than that of MOSFETs), fast current rise time (e.g., 50 ns), and a low turn-off delay time (e.g., 150 ns). The diode 460 can be configured to provide a current path when the transistor circuitry 450 is off and to provide overvoltage protection. The IGBT 452 can be significantly overloaded with current for a short time without causing a breakdown. Some other transistors can allow a short circuit for a certain time, without breakdown. The transistor circuitry 450 can satisfy predetermined characteristics of operating current, voltage, switching speed, and turn-off delay in accordance with certain implementations described herein.

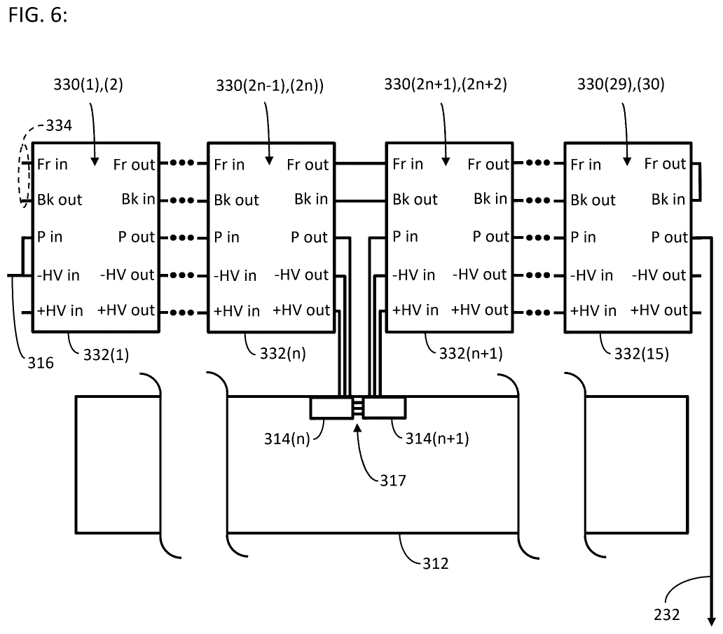

In certain implementations, the plurality of third PCBs 332 are connected in series with one another and the plurality of Marx cells 330 are connected in series electrical communication with one another. FIG. 6 schematically illustrates the plurality of third PCBs 332 connected in series with one another in accordance with certain implementations described herein. As shown in FIG. 6, the +HV output, −HV output, and pulse output signal lines of a third PCB 332(n) can be connected to the +HV input, −HV input, and pulse input signal lines of an adjacent third PCB 332(n+1), respectively. For example, the +HV output, −HV output, and pulse output signal lines of the third PCB 332(n) can be connected to a corresponding second connector 314(n) of the at least one first PCB 312, the +HV input, −HV input, and pulse input signal lines of the adjacent third PCB 332(n+1) can be connected to a corresponding second connector 314(n+1) of the at least one first PCB 312, and the at least one first PCB 312 can comprise signal conduits connecting the respective signals lines 317 of the second connectors 314(n),(n+1). The driver loop wire 334 can extend (e.g., in the forward direction) through one transformer 420 on each third PCB 332 of the plurality of third PCBs 332 and can extend (e.g., in the backward direction) through another transformer 420 on each third PCB 332 of the plurality of third PCBs 332. As shown in FIG. 6, a portion of the driver loop wire 334 can extend from one transformer 420 on the last third PCB 332 into the other transformer 420 on the last third PCB 332. The pulse output signal line of the last third PCB 332 is connected to a signal conduit configured to transmit the pulse power output signals 232 from the modulator 230.

As shown in FIG. 3A, the plurality of third PCBs 332 can comprise 15 individual PCBs, each of which is connected to the at least one first PCB 312. Each of the third PCBs 332 can comprise two Marx cells 330 of the plurality of Marx cells 330 that are connected in series electrical communication with one another (see, e.g., FIGS. 3A, 5A, and 5B), with a total of 30 Marx cells 330. While FIGS. 5A, 5B, and 6 show that each third PCB 332 comprises two Marx cells 330, other numbers of Marx cells 330 per third PCB 332 (e.g., 1, 3, 4, or more) are also compatible with certain implementations described herein. While FIGS. 3A and 6 show that the plurality of third PCBs 332 comprises 15 third PCBs 332, other number of third PCBs 332 (e.g., in a range of 4 to 50) are also compatible with certain implementations described herein.

In certain implementations, the total loss of the power supply 200 is in a range of 100 W to 400 W (e.g., 202 W). The load power (e.g., including output power of the magnetron 110, electron source 120, and first and second filament power sources 240, 250, can be in a range of 20 W to 100 W (e.g., 75 W), such that the total power provided by the power supply 200 can be in a range of 250 W to 1200 W (e.g., 900 W). Table 2 provides some example power parameters of the system 10 in accordance with certain implementations described herein. Table 3 provides some example parameters of the Marx modulator 230 in accordance with certain implementations described herein.

TABLE 2

| | Voltage | Current | Efficiency | Losses |
|---|---|---|---|---|
| Unit | (V) | (mA) | (%) | (W) |
| Modulator 230 | 24,000 | 11 | 58 | 114 |
| DC power source 220 | 850 | 460 | 90 | 40 |
| First filament power | 11 | 5,000 | 92 | 4.4 |
| source 240 | | | | |
| Second filament power | 6.3 | 3,000 | 90 | 2 |
| source 250 | | | | |
| Grid bias power source | 100 | 300 | 90 | 3 |
| 260 | | | | |
| Driver first DC power | 12 | 1,000 | 50 | 0.5 |
| source 340 | | | | |
| Driver second DC power | 500 | 8 | 85 | 1 |
| source 350 | | | | |

The efficiency is a theoretical efficiency when working on an equivalent resistive load. When the modulator works with a magnetron, the efficiency should be significantly higher, since the transistors switch at zero current. The magnetron is a threshold device, which begins to conduct current only at a certain voltage.

TABLE 3

| Modulator Parameter | Value | |
|---|---|---|
| Maximum output voltage | 25 | kV |
| Maximum output current | 30 | A |
| Pulse width | 200-500 | ns |
| Rise/fall time | 50/100 | ns |
| Input high voltage | <900 | V |
| Auxiliary logic power source | 24 | V |
| Dimensions | 11.5 × 3.3 × 2.4 | inches |
| Weight | 2.65 | lbs. |

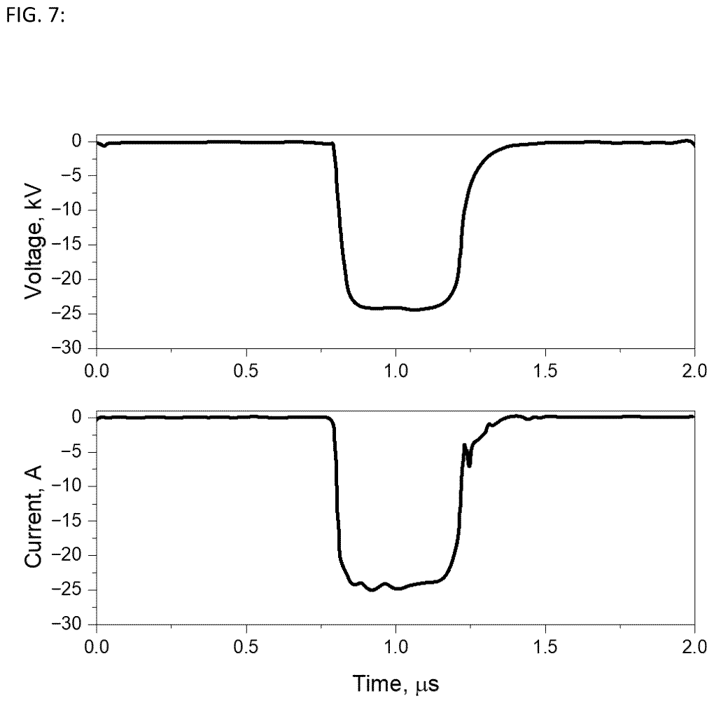

FIG. 7 is a plot of example measured voltage and current waveforms at the output of the modulator 230 connected to a resistive load of 1000 Ohm in accordance with certain implementations described herein. The amplitude of the pulse was 25.2 kV/24.5 A, current rise/fall time of the pulse was 46/97 ns, and the width (e.g., adjustable) of the pulse was 407 ns.

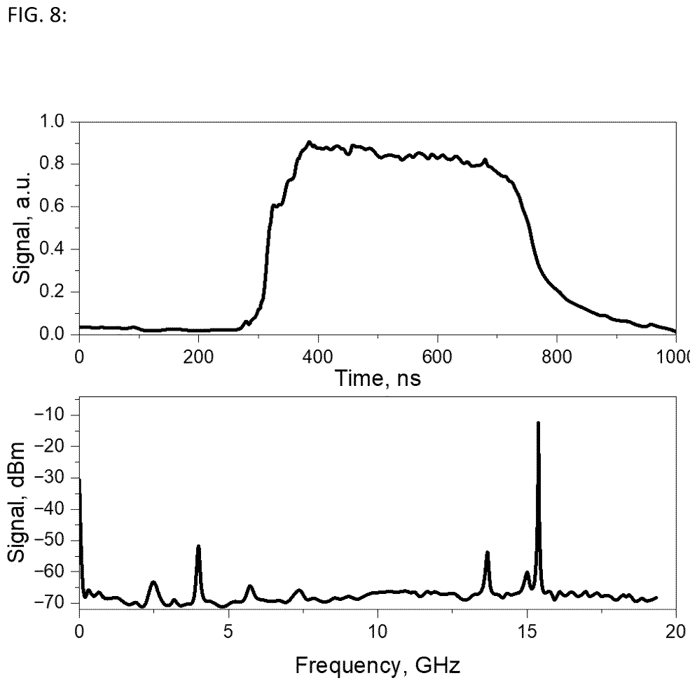

FIG. 8 is a plot of example measured RF signal envelope and example frequency spectrum at the output of the modulator 230 connected to the magnetron 110 in accordance with certain implementations described herein. The battery-powered first filament power source 240 isolated the cathode of the magnetron 110 from ground during the application of a high voltage pulse, with the cathode kept at high voltage during the measurement. The cathode heater current was 4.5 A for a voltage of 11 V. A load with a directional coupler was connected to the RF output of the magnetron 110 and power measurements were obtained through the attenuator. The flat-top pulse length at a level of greater than 0.9 is 350 ns.

The measurements were taken using two different methods to cross-validate the results. The first measurement method was performed using a digital signal analyzer. The total attenuation coefficient was measured to be 81.6 dB and the maximum power was 1.2 dBm, which corresponds to 190 kW. However, this value has an error associated with the sampling rate of the analyzer, which was limited to 50 GS/s, corresponding to only capturing three samples per RF period, which is not compatible with high accuracy.

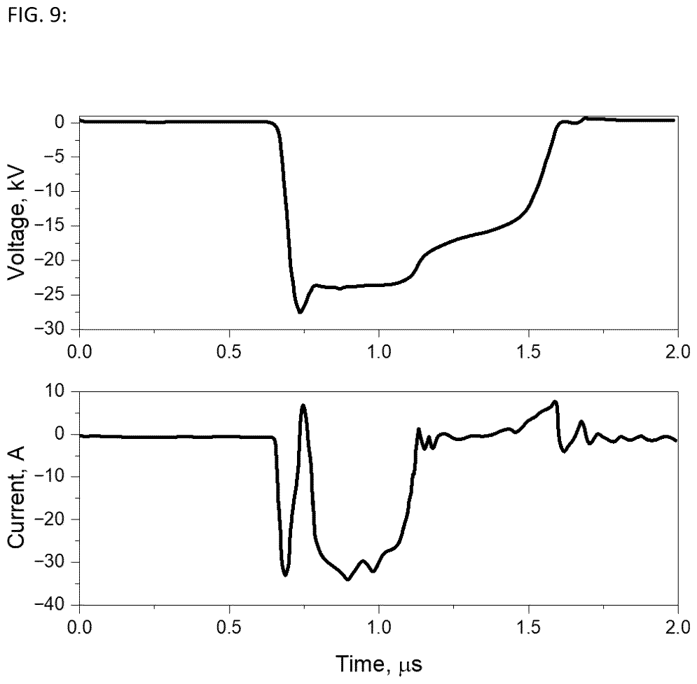

FIG. 9 is a plot of example measured voltage and current waveforms at the output of the modulator 230 connected to the magnetron 110 in accordance with certain implementations described herein. At the beginning of the pulse, while the magnetron 110 is off, the modulator 230 sees only a reactive load impedance, making the current oscillate, accompanied by a slight voltage change of about 4 kV. After the magnetron 110 begins to operate and the impedance of the magnetron 110 is greatly reduced, the current stabilizes at a value of about 30 A, which is slightly higher than the value of 24 A used for a VMU1724T magnetron.

The second measurement method was performed using a power meter. The total attenuation coefficient was measured at the same level of 81.6 dB and the peak power at the magnetron output was measured at +2.38 dBm, which corresponds to a power of 250 kW.

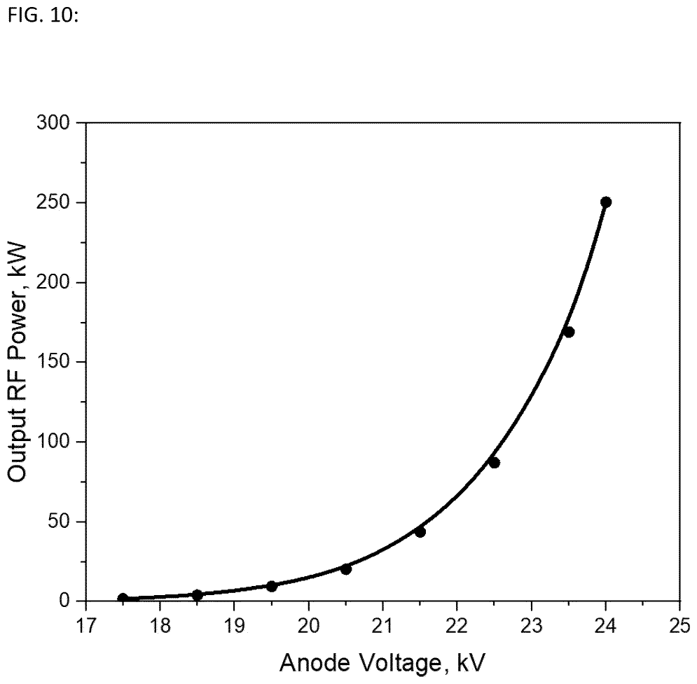

FIG. 10 is a plot of an example RF power generated by the magnetron 110 as a function of the pulse voltage of the modulator 230 in accordance with certain implementations described herein. The magnetron 110 starts generating RF power from a voltage of about 17 kV, and the output power then rises rapidly as the voltage increases. The magnetron 110 can provide a signal over a wide range of power levels (P, MW) from 20 kW to 250 kW that is related to beam energy (U, MV) and current (I) as P=(U²/Z)+U·I, where Z, MQ is the full shunt impedance of the accelerating structure. The output parameters of the modulator 230 connected to the magnetron 110 are compatible with x-ray generation by the magnetron 110.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of x-ray beam sources, various implementations described herein can be incorporated in a variety of other suitable devices, methods, and contexts.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another, and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

What is claimed is:

1. A modulator configured to provide pulse power output signals to a linac-based x-ray source, the modulator comprising:
control circuitry on at least one first printed circuit board;
driver circuitry on at least one second printed circuit board in reversible mechanical and electrical communication with the at least one first printed circuit board such that the driver circuitry is in operative communication with the control circuitry, the driver circuitry comprising a driver loop wire extending from the at least one second printed circuit board; and
a plurality of Marx cells on a plurality of third printed circuit boards in reversible mechanical and electrical communication with the at least one first printed circuit board such that the plurality of Marx cells is in operative communication with the control circuitry and the driver circuitry, the plurality of Marx cells configured to generate pulse power output signals, each Marx cell of the plurality of Marx cells comprising a transformer configured to trigger the Marx cell, the driver loop wire comprising a common primary winding of the transformers of the plurality of Marx cells.

2. The modulator of claim 1, wherein each third printed circuit board of the plurality of third printed circuit boards comprises at least one Marx cell of the plurality of Marx cells and at least one orifice extending through the third printed circuit board, the transformer of each of the at least one Marx cell comprising a toroidal core and a secondary winding wound around the core, and a center hole encircled by the core, the center hole aligned with a corresponding orifice of the at least one orifice, the driver loop wire extending through each center hole of each transformer of the plurality of Marx cells.

3. The modulator of claim 1, wherein each third printed circuit board of the plurality of third printed circuit boards comprising two Marx cells of the plurality of Marx cells and two orifices extending through the third printed circuit board, the transformer of each of the two Marx cells comprising a toroidal core and a secondary winding wound around the core, and a center hole encircled by the core, the center hole aligned with a corresponding orifice of the two orifices, the driver loop wire extending through each center hole of each transformer of the plurality of Marx cells.

4. The modulator of claim 3, wherein the driver loop wire extends through a first center hole of a first transformer on the third printed circuit board in a first direction and extends through a second center hole of a second transformer on the third printed circuit board in a second direction opposite to the first direction.

5. The modulator of claim 4, wherein the driver loop wire is in reversible mechanical and electrical communication with the at least one second printed circuit board.

6. The modulator of claim 1, wherein the control circuitry is configured to receive input synchronizing pulses and to provide output synchronization pulses to the driver circuitry.

7. The modulator of claim 6, wherein the driver circuitry is configured to respond to the output synchronization pulses by providing driving pulses to the driver loop wire.

8. The modulator of claim 7, wherein each Marx cell of the plurality of Marx cells further comprises:
an inductor configured to receive voltage signals;
a plurality of capacitors in parallel electrical communication with the inductor and in parallel electrical communication with one another; and
transistor circuitry configured to switch in response to the driving pulses on the driver loop wire.

9. The modulator of claim 8, wherein the transistor circuitry comprises an insulated-gate bipolar transistor, a diode, and a shunt resistor.

10. The modulator of claim 1, wherein the plurality of Marx cells are connected in series electrical communication with one another.

11. An x-ray generating system comprising:
an x-ray source comprising:
an electron source configured to provide electrons;
a linear accelerator configured to receive the electrons from the electron source and to apply radio-frequency (RF) electromagnetic fields to accelerate the electrons;
a magnetron configured to generate the RF electromagnetic fields; and
a target configured to respond to being impinged by the accelerated electrons by generating x-rays; and
a radio-frequency (RF) voltage power supply configured to provide electrical power to the x-ray source, the RF voltage power supply comprising:
a battery;
a DC power source; and
a modulator configured to receive electrical power from the battery and the DC power source and to provide pulse power signals to the electron source and the magnetron of the x-ray source, the modulator comprising:
a driving signal conduit;
a plurality of cells configured to generate the pulse power signals, each cell of the plurality of cells comprising a capacitor bank and a transformer configured to trigger the cell, the driving signal conduit comprising a common primary winding of the transformers of the plurality of cells.

12. The x-ray generating system of claim 11, wherein the battery comprises one or more lithium-ion batteries.

13. The x-ray generating system of claim 11, wherein the DC power source is configured to provide an adjustable output voltage to charge the capacitor banks of the plurality of cells.

14. The x-ray generating system of claim 11, wherein the RF voltage power supply further comprises:
a first filament power source in operative communication with the magnetron and the battery;
a second filament power source in operative communication with the electron source and the battery;
a grid bias power source in operative communication with the electron source and the battery.

15. The x-ray generating system of claim 11, wherein the modulator comprises a Marx topology.

16. The x-ray generating system of claim 11, wherein the plurality of cells comprises a plurality of Marx cells.
